(19) United States
(12) Patent Application Publication
(10) Pub. No.: US 2026/0161166 A1
(43) Pub. Date: Jun. 11, 2026

(54) SYSTEM AND METHOD OF COMPREHENSIVE PRODUCTION LINE MONITORING AND FAST REACTION IMPLEMENTATION

(71) Applicant: GM GLOBAL TECHNOLOGY OPERATIONS LLC, Detroit, MI (US)

(72) Inventors: Jesse Heidrich, Shelby Township, MI (US); James Butterworth, Mount Clemens, MI (US); Joshua Lee Solomon, Berkley, MI (US); Breona Warren, Sterling Heights, MI (US)

(73) Assignee: GM GLOBAL TECHNOLOGY OPERATIONS LLC, Detroit, MI (US)

(21) Appl. No.: 18/972,320

(22) Filed: Dec. 6, 2024

(51) Int. Cl. G05D 1/243

(52) U.S. Cl. CPC G05D 1/243

(57) ABSTRACT

A vehicle, system, medium and method includes operating, by at least one processor, at least one autonomous vehicle having multiple cameras and disposed to move in a vicinity of a production line arranged to provide a product. The operating comprises automatically moving the at least one autonomous vehicle in the vicinity of the production line while free of a predetermined fixed route, and capturing, by the multiple cameras, at least one sequence of images of an area including the production line. The method includes automatically recognizing, by at least one processor, at least one operation associated with the production line and captured in the at least one sequence of images, and providing instructions, by at least one processor, to perform a reaction in response to viewed actions of the recognized operations. The reaction is associated with the production line.

### INTRODUCTION

The present disclosure relates to production lines assembling a product at a manufacturing plant, and more particularly to automatic monitoring, analysis, reporting, and adjusting of production line operations.

Manufacturing plants monitor production or assembly lines to better ensure that the product assembly is being performed efficiently. This includes using camera array systems at each stage along the production line. The cameras are fixed and are placed at locations, such as overhead, to avoid interference with other moving objects such as robots or human operators at the lineside performing the assembly, piles of material to be used during the assembly, or the path and spaces for mobile vehicles delivering a payload to the lineside including autonomous mobile robots (AMRs) and/or automated guided vehicles (AGVs). Better positioning of cameras and greater integration between camera systems at different stages is desired to capture more informative perspectives of production for more accurate efficiency analysis.

Accordingly, it is desirable to provide systems and methods that enable more effective and efficient production line monitoring without significantly interfering with other production operations. Furthermore, other desirable features and characteristics of the present disclosure will become apparent from the subsequent detailed description and the appended claims, taken in conjunction with the accompanying drawings and the foregoing introduction.

### BRIEF SUMMARY

In an example implementation, a method includes operating, by at least one processor, at least one autonomous vehicle having multiple cameras and disposed to move in a vicinity of an object to be monitored. The vicinity is within a three dimensional space having overhead equipment to be avoided. The operating includes automatically moving the at least one autonomous vehicle in the vicinity of the object while free of a predetermined fixed route, and capturing, by the multiple cameras, at least one sequence of images of an area including at least part of the object. The method also includes automatically recognizing, by at least one processor, at least one change associated with the object and captured in the at least one sequence of images, and providing instructions, by at least one processor, to perform a reaction in response to the recognized change.

Also in accordance with another example implementation, the object is a production line arranged to provide a product, and the change is motion of an operation associated with the production line. The response includes responding to viewed actions of the recognized operation.

Also in accordance with another example implementation, the method includes operating multiple autonomous vehicles each capturing a different field of view of the production line to track an object traveling along the production line and passing through multiple ones of the fields of view.

Also in accordance with another example implementation, the method includes arranging a first autonomous vehicle to be monitored by one or more cameras of a second autonomous vehicle. The instructions include modifications of one or more actions to be performed by the first autonomous vehicle depending on the viewed actions captured by the one or more cameras of the second autonomous vehicle.

Also in accordance with another example implementation, the method includes carrying a loaded payload on the at least one autonomous vehicle, automatically detecting when at least a portion of the loaded payload is removed from the at least one autonomous vehicle or used in association with the production line or both by using the at least one sequence of images, and instructing the at least one autonomous vehicle to retrieve more payload when the detecting indicates at least the portion of the loaded payload was removed.

Also in accordance with another example implementation, the method includes generating a 3D map of the production line that changes over time, and determining and tracking a position and motion of the at least one autonomous vehicle on the 3D map by using the at least one sequence of images.

Also in accordance with another example implementation, the method includes using a visual simultaneous localization and mapping (VSLAM) algorithm to generate the 3D map of the production line and track the motion of the at least one autonomous vehicle.

Also in accordance with another example implementation, the multiple autonomous vehicles provide multiple sequences of images. The method includes registering images together from different ones of the multiple autonomous vehicles to generate a 3D map of the production line.

Also in accordance with another example implementation, the method includes comparing data of images of predetermined desired expected actions or previously recorded undesired actions or both to the viewed actions, and determining the instructions depending on results of the comparing.

In another example implementation, a system includes memory, processor circuitry forming at least one processor communicatively coupled to the memory and being arranged to operate by: operating at least one autonomous vehicle having multiple cameras and disposed to move in a vicinity of a production line arranged to provide a product. The operating includes automatically moving the at least one autonomous vehicle in the vicinity of the production line while free of a predetermined fixed route, and capturing, by the multiple cameras, at least one sequence of images of an area including at least part of the production line. The at least one processor is arranged to operate by automatically recognizing at least one operation associated with the production line and captured in the at least one sequence of images, and providing instructions to perform a reaction in response to viewed actions of the recognized operations. The reaction is associated with the production line.

Also in accordance with another example implementation, the at least one processor is arranged to operate by determining one or more differences between the viewed actions and corresponding previously stored images of expected action or undesired action or both by using the at least one sequence of images, informing a user of the differences on a display device remote from the at least one autonomous vehicle, and receiving instructions from the user to modify planned motion of the at least one autonomous vehicle depending on the differences.

Also in accordance with another example implementation, the at least one processor is arranged to operate by generating real-time 3D maps and having data of the production line and positions of multiple autonomous vehicles changing over time and by using the at least one sequence of images.

Also in accordance with another example implementation, the at least one processor is arranged to operate by: comparing the viewed actions to images of expected actions or undesired actions or both to determine action differences, and generating contents of the reaction depending on the differences including providing all alternative options of (1) providing a signal to send to at least one of the autonomous vehicles, (2) providing a signal to send to at least one non-AMR device in a vicinity of the production line, and (3) providing data to inform a person of the action differences.

Also in accordance with another example implementation, the at least one autonomous vehicle has a body connected to a movement mechanism, a base, and a payload area disposed above the base. The base includes sidewalls disposed below the payload area and having the multiple cameras each facing in an outwardly direction from the base.

Also in accordance with another example implementation, the multiple cameras are positioned on individual autonomous vehicles to capture images in 360 degrees horizontally around the individual autonomous vehicle.

In another example implementation, at least one non-transitory computer-readable medium includes instructions thereon that when executed by a computing device, causes the computing device to operate by: operating at least one autonomous vehicle having multiple cameras and disposed to move in a vicinity of a production line arranged to provide a product. The operating includes: automatically moving the at least one autonomous vehicle in the vicinity of the production line while free of a predetermined fixed route, and capturing, by the multiple cameras, at least one sequence of images of an area including at least part of the production line, automatically recognizing at least one operation associated with the production line and captured in the at least one sequence of images, and providing instructions to perform a reaction in response to viewed actions of the recognized operations. The reaction is associated with the production line.

Also in accordance with another example implementation, the instructions cause the computing device to operate by moving one of the autonomous vehicles along the production line to maintain one or more objects moving on the production line in view of the multiple cameras on the one autonomous vehicle.

Also in accordance with another example implementation, the instructions cause the computing device to operate by having multiple autonomous vehicles moving along the production line each following and capturing images of a different object moving along the production line.

Also in accordance with another example implementation, the at least one autonomous vehicle is arranged to monitor objects associated with the production line including at least one of: human operators, other autonomous vehicles of the at least one autonomous vehicle, objects moving in association with the production line, objects being added to the product, tools being used to assemble the product, objects moved from or to the at least one autonomous vehicle, and motion of robots.

Also in accordance with another example implementation, the at least one autonomous vehicle is arranged to track objects associated with at least one production line stage of: material preparation, fabricating components of the product, subassembly of parts of the product, assembly of the product, quality control testing of the product, surface treatment of the product, packaging of the product, storage of the product, and shipping of the product.

### BRIEF DESCRIPTION OF THE DRAWINGS

The present disclosure will hereinafter be described in conjunction with the following figures. The figures are not to scale and numerals in the figures denote like elements, and where:

FIG. 1A is a schematic diagram of an overhead view of an example autonomous mobile robot (AMR) system setup at a manufacturing plant according to at least one of the implementations herein;

FIG. 1B is a schematic diagram of an overhead view of another example autonomous mobile robot (AMR) system setup at a manufacturing plant according to at least one of the implementations herein;

FIG. 2 is a schematic diagram of a perspective view of an example autonomous mobile robot (AMR) monitoring an operation with an object for a production line according to at least one of the implementations herein.

FIG. 3 is a schematic diagram of a perspective view of an example autonomous mobile robot (AMR) at a lineside of a production line according to at least one of the implementations herein;

FIG. 4 is a schematic diagram of an example manufacturing plant system according to at least one of the implementations herein;

FIG. 5 is a schematic diagram of an example autonomous mobile robot (AMR) according to at least one of the implementations herein;

FIG. 6 is a schematic diagram of an example image processing unit for the autonomous mobile robot (AMR) or plant system of FIGS. 1-5 and according to at least one of the implementations herein;

FIG. 7 is a flow chart of an example method of operating an example autonomous mobile robot (AMR) according to at least one of the implementations herein; and

FIG. 8 is a flow chart of an example method of operating an example autonomous mobile robot (AMR) system according to at least one of the implementations herein.

### DETAILED DESCRIPTION

The following detailed description merely presents example implementations and is not intended to limit the disclosure or the application and uses thereof. Furthermore, no intention exists to be bound by any theory presented in the preceding background or the following detailed description.

The presently disclosed system and method provide highly adaptable, integrated, autonomous vehicles such as autonomous mobile robots (AMRs) each with sensors and camera arrays. The AMRs monitor any one or more stages of a production line from beginning to end in order to track operations along the production line and/or to track any part of the build of a single product for example, all while using a single system to analyze the image data from multiple AMRs along the production line. The operation of this AMR system is accomplished despite any obstacles along the production line and without limiting the movement of the AMRs to predetermined pathways or routes that remain fixed during operation of the AMRs.

The use of the AMRs enables dynamic camera array positioning and by extension, dynamic vision-based data analysis by permitting an AMR's sensors and cameras to “follow” and synchronize with the production line, and enabling real-time location-based data analytics. These analytics can then be leveraged through an AMR system dashboard or other plant systems (such as programmable logic circuits (PLCs)) to increase production line effectiveness, send digital inputs to plant floor systems, and trigger reactions to the captured images in real-time or near real-time. This may include the use of a single AMR that captures images over time that can be registered (or stitched) together, or multiple AMRs along a production line that can provide images at the same time to be stitched together. In either case, a 3D map (or digital or virtual model) of the production line can be generated, and the AMRs can be localized on the map. Further image analysis can be used to recognize production line operations and determine modifications to reduce delay and increase efficiency and performance.

In some forms, the AMRs carrying payloads to the lineside of the production line including components to be added to products being assembled and/or tools to be used by operators or robots at the production line. Thus, the disclosed vision-based AMR system with mobile AMRs may reduce or eliminate the reliance on other visual monitoring systems since the payload is carried by the AMR itself rather than occupying space to be avoided by the AMR. This also permits ‘just in time’ placement of the components and materials lineside of the production line while increasing the coverage of the camera arrays at the same time.

Such AMRs can provide real-time location reporting, optional line following, and maneuverability while the vision-based data analytics solutions herein include real-time location tracking, task time analysis, visual error-proofing, and payload element counting. The combination of the AMRs with such vision-based analytics also permits real-time repositioning (or position refinement) of the vision systems on the AMRs to better ensure consistent visual coverage all along the production line or where desired. The AMR system also further integrates gathered data inputs with in-plant data systems to enable manufacturing improvements in real-time. The data inputs can be used for and analyzed to enable real-time line rebalancing, trend analysis, part ordering, and AMR re-assignment.

As described below, the camera arrays can be placed on a base or platform of the AMRs where the payload is placed over the base. With this arrangement, overhead objects such as cranes, robot arms, and so forth, do not block the field of view of the cameras.

Also with this arrangement of methods to operate an AMR system, this also permits manufacturing plant personnel to analyze the integration and interactions of different systems across disparate sections of a single manufacturing line, further allowing the plant personnel to modify manufacturing line systems to improve overall performance. Also, the AMR system can perform real-time autonomous decision-making for line rebalancing, fleet management, material delivery, and so forth, thereby increasing the efficiency of manufacturing plants. The AMR system further enables manufacturing plant personnel to record human operator actions directly lineside, providing an un-biased and un-blocked view of true interactions between personnel and machinery and the work performed. The AMR system also may provide plant personnel with data analytics breaking down value-added versus non-value-added work effort per location, allowing the plant to modify the operations of a monitored location to increase value-added effort and overall performance. The AMR system also enables the simultaneous use of AMR technology and vision-based data analytics solutions in a single package.

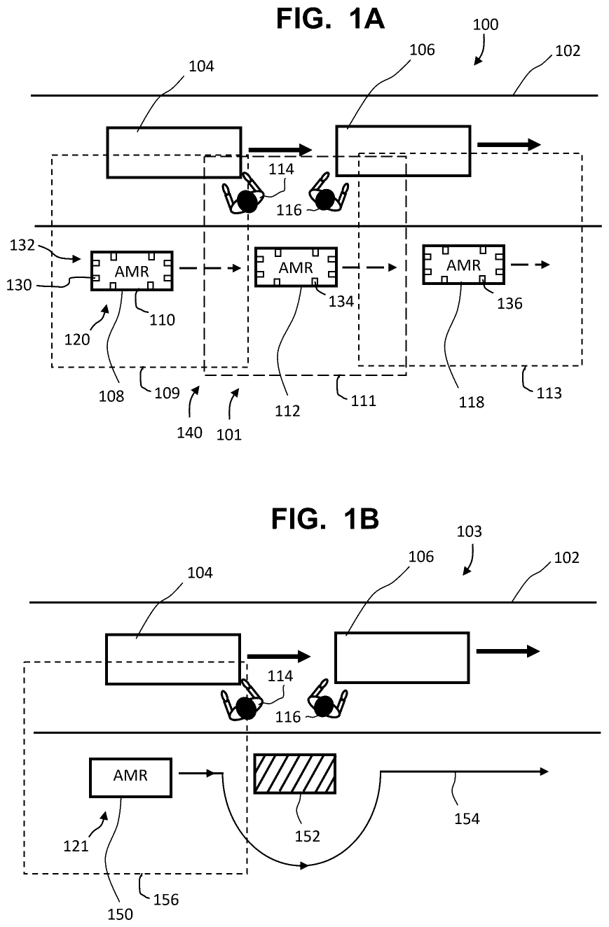

Referring now to FIG. 1A, a manufacturing plant 100 may include a plant system 101 with a production line 102 and products 104 and 106 being assembled along the production line 102 as the products (or some sub-assembly of the products) are moving along the production line as shown by the arrows. The products 104 and 106 are not limited to any specific product, and by one example, are automobiles. Human operators 114 and 116 may be performing tasks associated with the production line 102, and may include performing tasks to assemble the products 104 and 106.

The production line 102 may perform many different stages of a manufacturing process depending on the product being assembled. This may include any stage in manufacturing including material preparation, raw material handling, material cutting and shaping including any machining or molding, and so forth, component manufacturing, subassembly fabrication, part assembly, final assembly of the product, intermediate and/or final quality control, inspection, and testing, surface treatment, finishing, or coating such as painting, powder coating, anodizing, or other surface treatments, drying, curing, final or fine adjustments on the product, labeling operations including adding logos, seals, or decals, performance tests, packaging, storage, and shipping. Thus, any single stage or any combination of stages may form the production line 102 and is not particularly limited. For example, one or more parts of the production line 102 may be inside a building such as a factory or plant particularly with overhead equipment. It is often difficult, if not impossible, to maneuver overhead surveillance robots to avoid the overhead equipment.

The products 104 and 106 being assembled may be moved from stage to stage along the production line 102 using any suitable device depending on the product, including conveyor belts, cranes, dollies, carts or other vehicles, and so forth.

The plant system 101 also may have an AMR system 120 with one or more autonomous vehicles such as AMRs 108, here including AMRs 110, 112, and 118. The AMR system 120 is particularly suited to operate below overhead equipment within a building or factory, but by other alternatives may by used outdoors or other environments. By one form, the AMR system may be used to monitor many different objects within a building or factory such as infrastructure (building condition), other systems (fluid delivery system), or indoor factory traffic, such as at indoor factory intersections, and so forth to monitor pedestrians, operators, and moving equipment. By one example form, any object within a building, factory, plant, or other area such as a three-dimensional space with overhead equipment to avoid may be monitored as long as an autonomous vehicle is free to automatically set its own routes to perform the monitoring. By another form, the autonomous vehicles travel on the ground by wheels or another mobility mechanism that contacts the ground.

In more detail, each AMR 108 may have one or more cameras 130 forming a local or AMR camera array 132 on each AMR 108. Here, at least eight cameras 130 are provided on each AMR 108 with two cameras on each of four sides of the AMR 108, although any desired number of cameras and camera arrangements may be used. Collectively, the camera arrays 132 on all AMRs 108 cooperatively form a global or AMR system camera array 140. The cameras 130 are pointed outward so that each AMR camera array 132 establishes an aggregate (or AMR or local) field of view 109, 111, or 113. By one form, each AMR field of view 109, 111, and 113 is 360 degrees horizontally, and may be 180 degrees vertically depending on the cameras and camera positions. By one form, downwardly and/or upwardly facing cameras (not shown) may be on each or individual AMRs 108 as well to establish the 180 degree or 360 degrees vertical range of the fields of view 109, 111, and 113 when relevant.

As shown in this example, the AMRs 108 may be positioned lineside of the production line 102 and may either remain relatively stationary to monitor an assigned area of the production line, or may travel along the production line or any other desired path to or away from the production line. In the first case, the AMRs 108 may be assigned to a specific task or operation being performed at the production line that does not move along the production line 102 while the sub-assembled products 104 and 106 are moving along the production line. In this case, the fields of view 109, 111, 113 overlap with each other so that the onboard cameras 130 can maintain a view of successive production line operations as a product or other objects travel through the fields of view 109, 111, 113.

With the camera array 140 then, an AMR 108, or local camera array 132, may be assigned to monitor specific operations or tasks, and in turn more precisely specific viewable actions including motions of objects. The term objects herein may include the human operators unless the context is clear, or it is explained that the plant or factory floor personnel are not included. The monitored operations may be referred to herein as viewed or real actions versus predetermined expected actions described below. Here, the AMRs 108 may be monitoring observable or viewable actions in any of the production stages mentioned above or any others, and may include operators following a specified plan of work, operators installing a part, new parts being delivered, safety concerns being identified, sequence of operations being followed, use of personal protective equipment (PPE), tooling usage, task timing, and so forth. More specifically, such camera monitoring may include at least two broad categories: human operator (or personnel) actions and autonomous robotic operations. The AMR system 120 may monitor personnel tasks such as loading materials onto conveyors, assembling components, quality checking products, or adjusting machinery settings to monitor proper ergonomic practices, avoid bottlenecks, and comply with safety protocols, such as maintaining a safe distance from moving parts or operating machinery. Additionally, the AMR system 120 may monitor for proper handling in assembly, prompting corrective actions in real time. It should be noted that the term real time as used herein includes near real time and refers to that timing as perceived by a person and may have a processing lag time less than one second or up to a few seconds.

Otherwise, the AMR system 120 may monitor autonomous robotic actions such as picking and placing components, welding, packaging, or palletizing to name a few examples. The AMR system 120 may monitor these robotic motions to ensure the robots are functioning correctly with movements such as arm extensions, grasping actions, and material transfers being tracked for proper component placement, collision avoidance, or timeliness. Monitoring the robotic actions also allows for predictive maintenance, as the cameras can detect signs of wear and tear or irregular movements that indicate a need for maintenance before breakdowns occur.

Throughout the production line 102, the AMR system 120 also may monitor various stages such as in material handling, movement of raw materials from storage to the assembly area, checking for inventory issues, or identifying equipment malfunctions. During assembly, the camera arrays 132 can better capture when components are properly aligned and that workers are following assembly instructions and preventing defects. In the final stages, the AMR system 120 can verify the quality of finished products before they are packaged and shipped as well as monitor the quality control and testing operations being performed, ensuring that only products that meet the required standards move on to the next phase, ultimately contributing to better product quality, faster production times, and improved workplace safety. Many other examples of operations being monitored by the AMR system 120 may be used.

As another example alternative, the AMRs 108 may move (as shown by the dashed arrows) along with the movement of objects or products 104 and 106 at production line 102. In this example case, each AMR 108 may be assigned to a specific product 104 to monitor the assembly of that specific product. In this case, each AMR 108 may be assigned a different product, or a different part of a product where one AMR may be assigned to capture a front of the product, while another AMR may be assigned to a rear of that product. Many variations are contemplated. In this case, a single AMR 108 may monitor a sequence of varying operations and viewed actions that change along with the stage of the production line 102 as the AMR 108 moves along the production line 102.

Referring to FIG. 1B for yet another example arrangement, a plant system 103 is similar to the plant system 101 and has similar elements numbered the same that do not need to be described again. In this example, however, an AMR system 121 shows a single AMR 150 tracking a product 104 or other object or operator as the product 104 moves along the production line 102. As mentioned above, the AMR 150 may have cameras (not shown) to monitor a sequence of operations being performed on product 104. Also, in this case, the AMR 150 may autonomously change its linear path to a path 154 to avoid an obstacle 152 along an initial path. The path adjustment may occur relatively quickly as soon as the AMR 150 detects the obstacle 152. Once past the obstacle, the AMR 150 can resume the linear part of the path 154 to continue tracking the product 104.

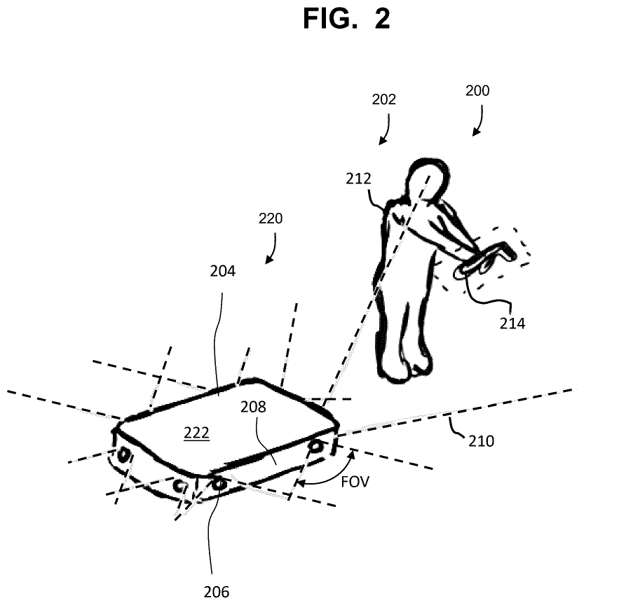

Referring to FIG. 2, a plant system 200 has a production line 202 monitored by an AMR system 220, similar to the AMR system 120, to show example camera positions and to demonstrate tracking of a human operator (or plant personnel). Thus, in this example, an AMR 204 has eight cameras 206 each with a field of view (FOV) shown in dashed lines and overlapping to form a continuous 360 degree total AMR FOV around the AMR 204. The AMR 204 may have a body 222 with sidewalls 208 where the cameras are mounted on, or have windows on, the sidewalls 208. As with the AMR 108, each different side (front, back, right, left sides) of the sidewalls 208 has two cameras 206 although many other configurations may be used instead.

Alternatively, the individual AMRs may have camera mounts, which may be adjustable mounts or robotic arms to position the cameras optimally for greatest field of view coverage particularly when the AMR 500 does not carry a payload and the positioning of the cameras if less restricted.

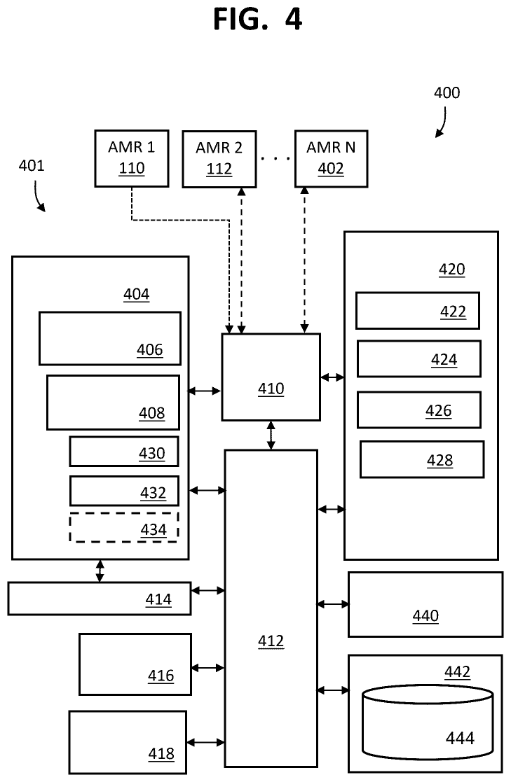

Also as part of this example, a human operator 212 may be moving an object 214 whether a sub-component of a product being assembled, a tool, or other object. The operator 212 and object 214 are within an FOV 210 of one of the cameras 206 on the AMR 204 so that object 214 can be recognized and identified by the plant system 200 (explained in detail with FIG. 4). The motion of the operator 212 and the object 214 is recorded over time so that the operator's performance of the movement of the object can be analyzed.

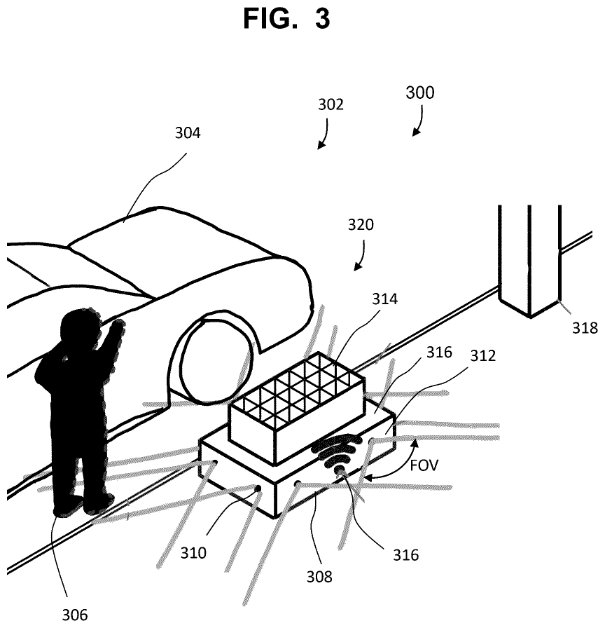

Referring to FIG. 3 for another example form, a plant system 300 has a production line 302 monitored by an AMR system 320 where AMRs 308 also are used to carry payloads 314 to the lineside of the production line 302. The plant system 300 has many of the same features as that of the plant systems in FIGS. 1A-2 and need not be described again. In this case, the production line 302 produces products 304 such as automobiles as one example, and a human operator 306 is performing an operation on the product 304. The AMR system 320 has an AMR 308 with eight cameras 310 on sidewalls 312 of the AMR 308, as with example cameras 130 and 206, and each camera has an FOV as described above. In this example, a fixed object 318, here being a plant column or other object, may be used as an anchor point for building the 3D map of the production line by using the cameras 310 as well as to localize the AMR 308 and detect and recognize the operator 306. The AMR 308 in this case has an upper surface 316 below a payload 314 that the AMR 308 is carrying. The upper surface 316 may or may not be in direct contact with the payload 314 and may have many different shapes and mechanisms to receive, hold, and provide elements of the payload 316. Many variations exist and the AMR systems 120, 121, and 320 herein are not limited to any one arrangement for holding or carrying the payload 314.

Referring to FIG. 4, a plant system 400 according to at least one of the implementations herein may include any of the production lines as described above and may have an AMR system 401 that here may include AMRs 1 to N (110, 112 to 402 as shown) located on a plant or factory floor and similar or the same as with the AMR systems 120, 220, and 320 described above. The AMR system 401 alternatively may be considered separate from plant system 400 since many units of the plant system 400 such as a control center that may be remote from the AMRs on a factory or plant floor.

The AMR system 401 may have an AMR control 404 with at least an image processing unit 406, an action difference unit 408, a motion unit 430, a camera unit 432, and an optional payload unit 434. An AMR dashboard unit 414 may or may not be considered part of the AMR control 404 and may be considered part of other systems on the plant system 400. The remainder of the plant system 400 that may be remote from the AMRs may have at least one each of a communications unit 410, a plant data center (or unit) 412, a display device 416, and/or a user interface 418. The plant system 400 also may have plant operation systems 420 that may include at least a materials unit 422, an E-stop unit 424, an alert unit 426, other programmable logic circuits (PLCs) or units 428 that operate various systems and control machinery and computing devices within the plant and at the plant floor or have mechanisms to initiate reports to personnel managing or performing operations at the plant floor. It will be appreciated that the term plant or factory floor herein refers to any location that is used for operations associated with a production line.

The plant system 400 also may include one or more processors 440 and memory 442 to operate any of the units or systems of the plant system 400, and the processors 440 and memory 442 may be considered part of any of the units of the plant system 400 described herein including any of the programmable logic controllers (PLCs) 428. One or more of the processors 440 and memories 442 may be provided for any of these units or systems being located and remotely from any of the other units or systems of plant system 400.

Now in more detail, the processor(s) 440 is provided to perform the computation and control functions of any of the units and systems of the plant system 400 and the AMR system 401 including the AMR control 404, and may be referred to as a control, controller, plant system, computing device, computer, and so forth. The processor 440 may have circuitry that may be part of, or form, the AMR control 404. The processor 440 may comprise circuitry or circuits that form any type of processor or multiple processors including central processing units (CPUs), digital signal processors (DSPs), single integrated circuits such as a microprocessor, or any suitable number of integrated circuit devices and/or circuit boards working in cooperation to accomplish the functions of a processing unit. This may include a System on a Chip (SoC) and one or more processor cores. The processor(s) 440 also may include image processing technology including graphical processing units (GPUs), image signal processors (ISPs), application-specific integrated circuits (AISCs), field programmable gate arrays (FPGAs), neural processing units (NPUs), vision processors (VPs), video processing units (VPUs), and deep learning accelerators (DLAs). These processors may be shared or specific purpose hardware. Also, dedicated or specific function processors may be provided that operate neural networks, machine learning, and other structures for image processing for example, such as with graphical processing units (GPUs) or image signal processors (ISPs). During operation, the processor(s) 440 executes any of the units or systems of plant system 400, and the units and systems of the plant system 400 may be in any combination of hardware, firmware, and/or software. The software portions of the units or systems may be stored on the memory 442 and, as such, controls the general operation of the plant system 400 and the AMR system 401 in executing the plant system processes described herein, such as the processes and implementations in any of FIGS. 1-3 and 7-8 and as described further below in connection therewith.

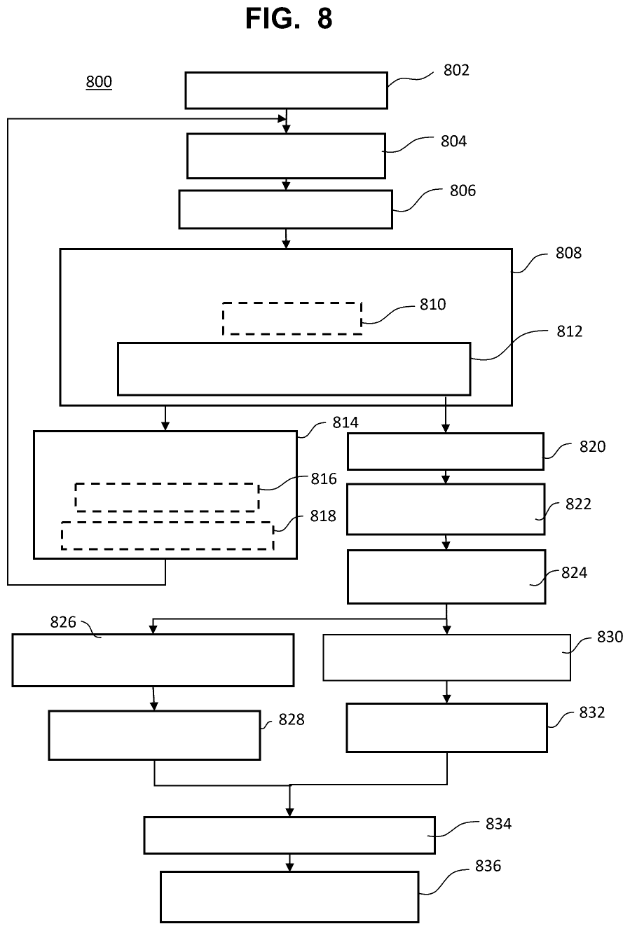

The memory 442 is meant in the general sense and can be any storage device and can include any type of suitable memory. For example, the memory 442 may include various types of dynamic random access memory (DRAM) such as SDRAM, the various types of static RAM (SRAM), as well as cache, while the memory 442 also may include various types of non-volatile memory (PROM, EPROM, and flash). In certain examples, the memory 442 is located on and/or co-located on the same computer chip as the processor 440. In the depicted implementation, the memory 442 stores the above-referenced plant system and AMR system units along with one or more databases to store map and image processing data and other stored values 156. Otherwise, the memory 442 can include various different types of direct access storage and/or other memory devices. In one example implementation, the memory 442 comprises a program product (or unit or system) from which memory 442 can receive a program that executes one or more implementations of the processes and implementations of FIG. 8 and as described further below in connection therewith. In another example implementation, the program product may be directly stored in and/or otherwise accessed by the memory 442 and/or a secondary storage device (e.g., disk). During operation, the program and accompanying data is stored in the memory 442 and the program is executed by the processor 440.

Thus, by one example, the memory 442 may store data of both the action difference unit 408 as well as action datasets at an action database 444 of both expected actions and corresponding undesired, previously captured actions (also referred to as the historical or dataset of “unexpected” actions) associated with any of the production lines described herein. The processors 440 may be used to operate the action difference unit 408 to determine differences between viewed actions and expected actions (and/or similarity between viewed actions and undesired (or unexpected) actions). Such differences and similarities may be compared to image processing thresholds, such as pixel distances or sum of absolute differences (SAD) type comparisons, and so forth determined by experimentation.

The plant system 101 may have hardware forming or supporting the processor 440, memory 442, and any other unit or system on the plant system 400, and the hardware may include at least one bus to transmit programs (e.g., units or systems), data, status, and other information or signals between the various components of the plant system 400. The bus can be any suitable physical or logical arrangement of connecting computer systems and components. This includes, but is not limited to, direct hard-wired connections, fiber optics, infrared and wireless bus technologies.

It will be appreciated that while this example implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 440) to perform and execute the program. Such a program product may take a variety of forms in memory 442, and the present disclosure applies equally regardless of the particular type of computer-readable signal bearing media used to conduct the distribution. Examples of signal bearing media forming memory 442 include recordable media such as floppy disks, hard drives, memory cards and optical disks, and transmission media such as digital and analog communication links. It will be appreciated that cloud-based storage and/or other techniques may also be utilized in certain implementations. As mentioned above, it will similarly be appreciated that the processors 440 of the plant system 400 may include a variety of processors at a variety of locations performing a variety of functions for plant system 400, for example in that the processor 440 may be coupled to or may otherwise utilize one or more remote computer systems and/or other control systems. Thus, this includes each unit and system of plant system 400 having their own processor(s) as part of processors 440.

The example communications unit 410 may include a transceiver and antennas to communicate remotely with the AMRs, other remote systems, servers, devices, modules, or units. It should be noted that any parts or components (or units) of the plant system 101 can processing for any of the operations described herein related to AMR production line monitoring, analyzing captured images, and implementing reactions can be performed remotely when desired. By some examples, the communications unit 410 can receive inputs (such as a signal or data packet of image data, and AMR and object position data) via application programming interfaces (APIs), messaging queuing telemetry transport (MQTT) for real time tasks, representational state transfer (REST), and/or a Common Industrial Protocol (CIP) bridge to plant floor systems through wireless communications such as Wi-fi, Bluetooth, radio frequency (RF), near field communication (NFC), Ultra-wideband (UWB), and so forth. Thus, the communications unit 410 may communicate over networks including one or more computer networks such as the Internet, and communications networks (e.g., satellite-based, cellular, and/or any number of other different types of wireless communications networks). By one form, the communications unit 410 collects transmitted data (such as the images or signals from the AMRs) over the internet using a web address with a uniform resource locator (URL) that is an API.

One or more displays 416, such as computer monitors, smart phones, tablets, and so forth may be used to display AMR monitoring data and images from the AMR dashboard unit 414 to a user to inform a user of significant action differences and relevant alerts, and to receive (1) input from a user whether to establish AMR or other actions in the first instance and/or (2) modify AMR or other object actions as a response or reaction to the action differences, and by communicating with the PLCs or other units. By one form, the display 416 may be any that can provide a screen on a computer, smart phone, tablet or other computing device to see the images on the display 416. Such a display 416 may be a digital display, a graphical user interface (GUI), an LED display, a plasma display, an LCD display, an organic light emitting diode (OLED) display, a thin-film transistor (TFT) display, heads up display (HUD), 3D displays, holographic displays, virtual or augmented displays, and so forth. The details of use of the display 416 are explained below.

The user interface 418 allows communication between the user and to the other plant system and AMR system units as mentioned above. Thus, the interface 418 may include a touch screen on display device 416 or any other display, keyboard, and/or mouse operations, audio system, and/or other suitable interface devices and architecture. The user interface 418 can be mobile relative to the other units of the plant system 400, and may include smartphones or tablets held by or with personnel at the site (or plant floor or production line).

The plant data center (or unit) 412 may manage or have the memory 442 and/or action database 444 to store AMR data and provide inputs received from the AMRs along with differences from the action difference unit 408 to the PLCs 428 to determine what reaction to implement depending on the differences. Otherwise, the plant data center 412 may transmit AMR report data for display to the display device 416 and/or user interface 418. The plant data center 412, whether alone or in collaboration with the PLCs or other units, also may determine production line rebalancing, trend analysis, part ordering, AMR re-assignment, and so forth depending on the action differences. The plant data center 412 also may manage historical archives placed in memory 442 of the plant operations including the storage of viewed actions and corresponding expected actions, undesired actions, action differences, and the resulting reaction implemented in response.

Otherwise, the plant data center 412 also may serve as a technological hub and overseer for collecting, storing, and analyzing data generated by manufacturing operations, and may integrate data from sensors, AMRs, other machines, and control systems to monitor real-time performance, track production metrics, and optimize processes, which may or may not related to the AMRs. The data center 412 may support predictive maintenance, helping prevent equipment failures, and may enable automation for improved efficiency, while also managing energy usage, inventory, and supply chain data, and ensuring security and regulatory compliance.

The AMR control 404 receives at least the image data of image sequences from each camera and AMR position data, but optionally also may receive local AMR maps or 3D maps. By one form, individual AMRs also may have their own AMR controls to generate action differences whether on a global scale including all AMR cameras or a local AMR scale at each AMR. In these cases, the action differences also may be provided to a central AMR control 404. Many variations are available.

In the present example, the AMRs do not have their own action difference capability and that is centralized at AMR control 404 remote from the AMRs, although as mentioned other approaches can be used. Here, the inputs are received through the communications unit 410. The image processing unit 406 then analyzes the various images by registering images from different cameras and forming a 3D model or map of the production line. By one example, different local AMR 3D maps from multiple AMRs are stitched together or multiple local 3D maps from a single AMR that is moved to capture different perspectives are stitched together. By one example form, this is performed by using feature matching algorithms such as Visual Simultaneous Localization and Mapping (VSLAM) and/or other algorithms described below. The same or other object recognition algorithms then may be used to then identify operations and motions in the sequences of the images to generate recognized viewed actions for comparison to predetermined expected actions and/or predetermined undesired actions from the actions database 444. Thereafter, the action difference unit 408 determines and reports the differences between viewed and expected actions (and similarities between viewed action and undesired actions when being used). The details of this process are provided below with process 800 (FIG. 8).

The motion unit 430 provides motion instructions to the AMRs and modifies instructions when needed due to the action differences. Thus, the motion unit 430 may provide broad instructions for an AMR to travel to a certain location, while the AMR itself may determine the exact path to that location. The motion unit 430 may override the AMRs path generating controls when the difference in action indicates a certain path must be followed by the AMR. Many variations are contemplated.

The camera unit 432 may control operations of the cameras on all AMRs by monitoring when the cameras are activated or deactivated, ensuring the cameras are directed to desirable directions, focus level, and other camera settings. The camera unit 432 also may provide modifications and updates for image quality and so forth.

The optional payload unit 434 is provided when at least one of the AMR carries a payload. The payload unit 434 may monitor payload amounts on one or more of the AMRs, and provide instructions for moving an AMR to a payload loading dock or area to retrieve more payload and to a desired lineside location at the production line.

The AMR dashboard unit 414 may display the action differences on the display device 416 for example, as well as other data related to the AMR performance. The AMR dashboard also can be used to provide a list and view of variety of available reports, create custom reports requested by the user, display historical data, or provide other reports for viewing by the user. The AMR dashboard unit 414 also may receive inputs from a user requesting information or providing instructions to generate a reaction to the action differences, and this may include updating programming of various AMR or plant system through the AMR dashboard unit 414 although other interfaces may be used instead.

The plant operation systems 420 manage the different systems operating the production line and other areas of a manufacturing plant. For example, the PLCs 428 may receive data associated with an action difference and then decide what is the appropriate reaction, generate instructions for the AMR or other device implementing the reaction, and initiate reports associated with the action difference including providing data or instructions to the other units of the plant operation systems 420 as well as report viewable to a user.

Otherwise in some forms, example PLCs 428 also may be provided to process inputs from sensors, switches, and other devices, control outputs such as motors, actuators, and valves, and manage a wide range of operations. This may include sequential controls such as controlling the stages in the production line, process controls such as monitoring and regulating variables such as temperature, pressure or flow, motion controls coordinating the movement of machines or robotic arms, safety systems that ensure emergency shutdowns or safety interlocks, material handling such as with the AMRs, conveyor systems, or robotic pick-and-place operations, and communications integrating with other systems such as Supervisory Control and Data Acquisition (SCADA) or manufacturing execution system (MES) for factory-wide data exchange.

The materials unit 422 may receive instructions to retrieve more materials from the PLC 428 and then instructs the payload unit 434 to control an AMR to retrieve more materials and may provide the retrieval instructions to another device or personnel at the production line (or materials supply location. Many variations exist.

The E-stop unit 424 may receive instructions from the PLC 428 to stop operations at all or part of the production line, which is then implemented by the E-stop unit 424 by sending signals to devices or computing systems controlling the production line. Many variations exist.

The alert unit 426 may receive instructions from the PLC 428 to provide an alert to users and personnel working on or otherwise associated with the production line to warn about significant action differences (or all action differences). Data of such alerts may be provided via the plant data center 412 and to the AMR dashboard unit 414 to display the action difference (or anomalies) and other related data on the AMR dashboard unit 414 to a user on the display device 416. Other details of the operation of the plant system are provided below with process 800 (FIG. 8).

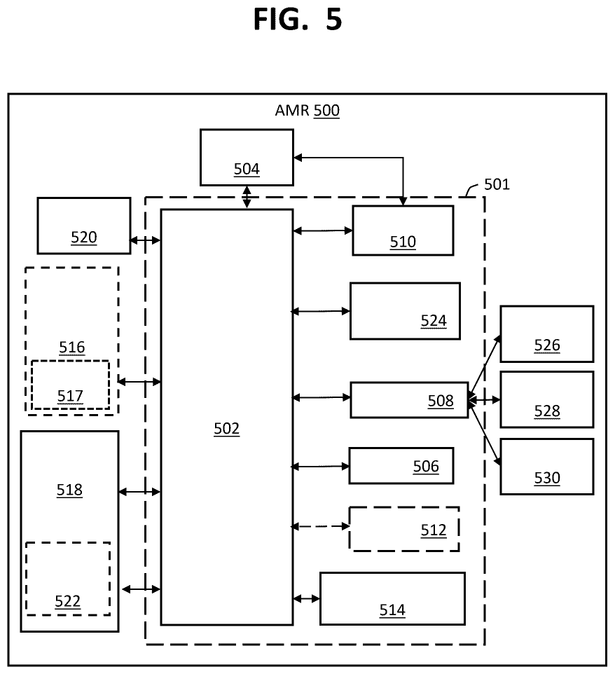

Referring to FIG. 5, an example autonomous vehicle such as an autonomous mobile robot (AMR) 500 is the same or similar to the AMRs of AMR systems 120, 220, and 401 described above. In one example implementation, the AMR 500 may have a controller 501, cameras 504, wheels 526 or other transportation mechanism, motor(s) 528, a steering mechanism 530, sensors 520, a local user input device 516 that may have a display device or screen 517 (or additionally or instead, speakers and/or microphones of an audio system), and a data storage 518 that may store the programs or code for any of the units of the AMR 500. By some alternatives, the data storage unit 518 also may store the programs or code of an image processing unit 522 and/or any other unit described herein that is used to analyze image data from the cameras 504 of any of the AMRs 500 and in addition to, or instead of, the units that analyze the image data at the plant system 400. Thus, such image processing units 522 may be provided on at least one of the AMRs, some of the AMRs, or none of them, and may analyze image data from just the AMRs own camera array or may receive images from other AMRs of the global camera array including all AMRs. Otherwise, the data storage unit 518 may have any of the hardware structures mentioned above for memory 442.

By one example form, the AMR may have wheels 526 to move but may have any other suitable mechanical transportation device or system such as a skate blades, rollers, fan propeller whether for vertical rotation as with fanboats or horizontal rotation as with drones or helicopters, and so forth. The wheels 526 may be differential drive, omnidirectional, or all-terrain type wheels that provide flexibility in movement without being constrained to tracks. The wheels 526 may be operationally connected to axles or other mechanisms connected to one or more motors 528 including both propulsion motors and steering motors. The motors 528 may be electric, fuel, or other type of motor. A steering mechanism 530 also may be connected to the wheels 526 to steer one or more of the wheels having a steering mechanism such as tie rods and a steering rack that turn one or more wheels 526 to control the direction of movement of the AMR 500. Many other configurations and arrangements may be used as long the AMR can be autonomously steered and driven.

The sensors unit 520 may include the sensors themselves and any processing to collect sensor data and provide the sensor data in an expected format. This may include sensors such as light detection and ranging (LIDAR), other cameras, ultrasonic sensors, and infrared sensors that help the robot perceive its environment and detect obstacles. Other sensors that may be provided include detection sensors (e.g., radar, sonar, or the like) and/or other sensors (e.g., vehicle position sensors, speed sensors, accelerometers, gyroscopes, inertial measurement unit (IMU) sensors, braking sensors, steering sensors, and so on). In various implementations, the sensors 520 obtain additional information as to the production line environment and/or the operation of the AMR 500 itself (e.g., position, speed, deceleration and/or acceleration thereof, and so on) for use in operating the AMR 500, for example in accordance with autonomous operation of the AMR 500 and/or of certain components thereof.

By some implementations, the cameras 504 used to obtain images of the observational or perception data of the production line or surrounding environment may include front, rear, side, upper, lower, and/or surround-view cameras on the AMR 500 including wide angle, 360 degree, and/or fish-eye lens cameras, as well as monocular, stereo, infrared, time-of-flight, thermal, LIDAR cameras, high-resolution cameras (e.g., RGB, depth, thermal) cameras, and so forth. These cameras 504 may capture images that are then processed as described herein. In various implementations, video camera images are obtained. Additionally or alternatively, still camera images may be obtained.

The local user input devices (or interfaces) 516 and display device 517 are as described above with user interface 418 and display device 416. The interface 516 may be used to view output data from the AMR 500 or input data to the AMR 500, whether to determine the status of the AMR 500 or otherwise control any feature of the AMR 500.

By one example implementation, the AMR controller 501 has one or more processors 502, a power unit 506, a mobility unit 508, a navigation unit 510, an optional local payload unit 512, a communications unit 514, and an AMR local control unit 524.

The processor(s) 502 may be formed by processor circuitry that operates or forms any of the units or systems on the AMR 500. Thus, the processors 502 are formed of the architecture alternatives mentioned above for processors 440 (FIG. 4). Likewise, the communications unit 514 is similar to the communications unit 410 of the plant system 400 and may include a transceiver and antennas to transmit AMR image data as well as any AMR related data generated by the local image processing unit 522 or sensors 520 such as position and orientation data, and so forth, as well as any other AMR data including status data, performance data, and so forth. The communications unit 514 also receives any instructions, requests, or any other data to control the AMR.

The power unit 506 may control and/or have the power source of the AMR 500 and may be any suitable power source including electrical power sources whether battery, AC, or DC, and more specifically, lithium-ion batteries. Some AMRs may use any one or more of lead-acid batteries, fuel cells, hydrogen-powered fuel cells, and supercapacitors with or without other batteries. Additionally, the AMR 500 may be wirelessly charging or inductive charging.

The mobility unit 508 controls the motors 528 to, in turn, control the steering mechanism 530 and wheels 526 (or other transportation mechanism) being used.

The AMR local control (or unit) 524 controls the actions of the AMR including receiving and analyzing instructions and commands whether from its own onboard protocols or from received messages or signals instructing or commanding the AMR to perform certain tasks. By one form, and in various implementations, the AMR local control 524 is coupled to the sensor unit 520, as well as to the mobility unit 508, the navigation unit 510, and the payload unit 512 when provided. In various implementations, the AMR local control 524 is also coupled to the data storage unit 518, the display device 517, and the communications unit 514. The instructions may include software protocols for data transmissions and coordination with other systems as well as manage image processing by the image processing unit 522 or navigation unit 510 to self-localize on a map of the production line, move the AMR to target destinations from the protocols or received instructions, and while avoiding obstacles and so forth. Thus, the AMR local control unit 524 may operate operating systems and algorithms that manage tasks such as path planning, decision-making, and obstacle avoidance including the operation of image processing unit 522. The AMR local control unit 524 also may control the operation and settings of the camera array on the AMR as well as the transmission of the image data and position data to the plant system 400 when generated.

The navigation unit 510 may perform local image processing and/or sensor data processing as instructed by the AMR control unit 524 to generate an AMR-level local 3D map when not relying on the image processing unit 522 or image processing unit 406 of the plant system 400 (FIG. 4). By one form, the navigation unit 510 concentrates on forming a 3D map and localization, while the image processing unit 522 focuses on localization and recognition of other objects and operations being captured by the cameras 504 in order to provide locally determined viewed actions from the AMR 500 rather than having the remote image processing unit 406 determine the viewed actions. Otherwise it will be appreciated that the plant system 400 may divide up the image processing tasks to the image processing unit 522, navigation unit 510, and image processing unit 406 of the plant system 400 and in whatever delegation of tasks is found to be most efficient, timely, or best in performance. Also and alternatively, 2D maps may be used instead of 3D maps when sufficient.

The optional payload unit 512 may control payload carrying operations when AMR 500 carries a payload. This may include receiving data of a count of the elements of the payload being used and captured in images by one of the image processing units 522 or 406, determining a target timing or time point to retrieve more payload, initiating the retrieval in coordination with the AMR local control unit 524 to move the AMR 500 as needed to retrieve a payload without disrupting the monitoring of the production line. More details of the operation of the AMR 500 are provided below with process 700.

It will be understood that in one example form, all of the units of the AMR controller 501 and data storage unit 518 may be mounted on or within a body of each or individual AMRs 500. By other alternatives, any parts or components (or units) of the controller 501 and data storage 518 that performs processing for any of the operations described herein related to AMR monitoring can be performed remotely when desired. Specifically, in various implementations, the controller 501 is disposed within the body of the AMR 500. In certain implementations, the controller 501 and/or the AMR local control 524 and/or one or more components thereof may be disposed outside of the body of the AMR 500 (such as body 222 of AMR 204 (FIG. 2)), for example, on a remote server, in the cloud, or other device where image processing is performed remotely. It will be appreciated that the controller 501 and/or the AMR local control 524 may otherwise differ from the implementation depicted in FIG. 5. For example, the controller 501 may be coupled to, or may otherwise utilize, one or more remote computer systems and/or other control systems, for example as part of one or more of the above-identified AMR 500 devices and systems.

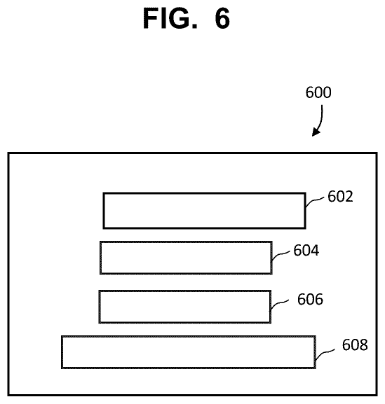

Referring to FIG. 6, an image processing unit 600 may be the same or similar to that of the image processing unit 406 or 522. The image process unit 600 may include a separate registration or stitching unit 602 that is used when the registration itself is not performed by a mapping unit 604. The image processing unit 600 also may have a triangulation unit 606, and an action recognition/verification unit 608. One or more of these units may be considered to be separate from the image processing units or may be considered to be part of a different unit of the AMR 500 (FIG. 5) or plant system 400 (FIG. 4).

By one example first approach, the image processing unit 522 and AMR local control 524 on the AMR 500 performs the initial operations to register images together from different cameras to form an AMR or local 3D map, localize the AMR, and perform object recognition to avoid obstacles, while the image processing unit 406 on the AMR control 404 of the plant system 400 level may perform the object recognition and operation identification to recognize viewed actions. In one case, the AMRs transmit input having the image sequences and AMR position data to the plant system level, although the local 3D maps be sent as well. The action differences are then determined by the action difference unit 408 remote from the AMRs. Otherwise, these tasks may be shared or balanced between the two image processing units 406 and 522 in other ways such as when practical and to increase efficiency and performance, and reduce delay to achieve real-time analysis to implement fast reactions at the production line as needed or desired. Thus in second alternatives, the AMRs do more of the image processing on-board, where one or more of the individual AMRs have the AMR control 404 to generate global 3D maps, localization of multiple AMRs, and databases and action difference unit 408 to recognize viewed actions, which are then sent to the plant system 400 level. By yet a third option, the AMRs do the bare minimum image processing on-board where a remote AMR control 404 may receive the image sequences from the AMR cameras and performs the image processing for generating any 3D map for localizing the AMRs. Any desired combination or variation of these may be used.

Now in more detail, the image registration unit 602, when separate from the mapping unit 604 and local on the individual AMRs, receives at least the AMR camera array images from the AMR's own onboard cameras although the images from the other AMRs may be received as well to have images from the global camera array of all or multiple AMRs being used at or associated with a same production line. This image registration unit 602 then performs registration or stitching which may be performed by many different feature detection and feature matching algorithms. Such techniques may include Scale-Invariant Feature Transform (SIFT), Speeded-Up Robust Features (SURF), Oriented FAST and Rotated BRIEF (ORB), and Kernel Aligned Zero-mean Extended (AKAZE or accelerated KAZE) to identify distinctive points in the image that are invariant to scale, rotation, and in some cases, affine transformations. Other feature matching techniques, such as Fast Library for Approximate Nearest Neighbors (FLANN) or BRUTEFORCE (simple exhaustive search) can be used to find correspondences between feature descriptors. Additionally, geometric verification methods, such as RANSAC (Random Sample Consensus) can refine matches by rejecting outliers and ensuring robust matches between image pairs.

The mapping unit 604 then forms a 3D map of at least a portion of the production line when cameras of a single AMR are used. This may cover the entire production line or at least that portion of the production line covered by the global camera array when the images from multiple AMRs are being used. By one form, Visual Simultaneous Localization and Mapping (VSLAM) or alternatively just SLAM is used and may perform both the image registration and mapping itself, which may include the use of one or more of the registration techniques mentioned above.

The VSLAM performs simultaneous mapping, localization, and tracking of the AMRs over time. Thus, the VSLAM may continuously update both the AMR's position and the map in real-time as the AMR moves, and this may be performed with only the visual data (the captured images), but may be enhanced by using the sensor data as well to confirm and refine the AMR positions and other objects when desired. The mapping involves identifying and tracking key features (such as corners, edges, or textures) in the visual data, which are then used to construct a 3D map of the space. This is continuously updated to track the motion of the AMR in real time. The localization also may determine the AMR's orientation within the map.

Thus, by one form, the VSLAM may perform feature detection, feature matching, camera motion estimation to determine camera positions and orientations (or poses) relative to the environment, the map building, which may be 3D map building or modeling, and the localization where the mapping and localization may be confirmed, filled in, and refined by using other sensors (such as LiDAR and/or GPS) for more accurate localization and mapping. Also, the VSLAM may perform feedback correction that includes correction for “scale drift” over time, where the estimated map gradually grows or shrinks in size due to errors in depth estimation. The AMR processors 502 (and/or 440) may include graphical SoCs with GPUs and deep learning capabilities to operate neural networks that handle the image data for the tasks mentioned above.

Alternatives to VSLAM, or algorithms that may be used in addition to VLSAM, or as part of VLSAM, may be any combination of the techniques mentioned above with the feature registration, or any combination of object detection and recognition algorithms such as those based on any one or more algorithms of: machine learning, neural networks, Convolutional Neural Networks (CNNs), Region-Based Convolutional Neural Networks (R-CNN), Recurrent Neural Networks (RNNs), Mask R-CNNs, You Only Look Once (YOLO), Single Shot MultiBox Detector (SSD), Semantic Segmentation such as Fully Convolutional Networks (FCNs) and U-Nets, for example, Haar Cascades (Viola-Jones (VJ) Detector), Histogram of Oriented Gradients (HOG), MOG (Mixture of Gaussians) background subtraction, template matching, DPM (Deformable Parts Model), GMM (Gaussian Mixture Model) background subtraction, LDA (Linear Discriminant Analysis), and/or many others.

Once localization and 3D mapping are established, the triangulation unit 606 may be used to detect, recognize, and identify other objects associated with, or on, the production line. Techniques such as Kalman filters, Optical Flow, and other techniques mentioned herein may be used to track moving objects and maintain their identities over time. Thus, the triangulation unit 606 also may include or establish a non-AMR object detection and recognition operation if not already performed by the VSLAM in the continuous 3D mapping and AMR localization operations. As mentioned above in one alternative, the non-AMR triangulation and object recognition may be performed entirely by the image processing unit 406 upon generating a global 3D map by registering images from all or multiple cameras from all or multiple AMRs. Alternatively, this may be entirely or partially performed by the image processing unit 522 on one or more of the AMRs. The object detection and recognition techniques mentioned above may be used and then triangulation applied to track positions of the objects where the objects can be any object within the fields of view of the cameras whether the product being assembled, robots or machinery used to perform the assembly or other tasks associated with the production line, and the human operators. This is performed continuously to track the motion of the objects captured in the global 3D map over time to capture an extremely accurate and precise model of the objects. By one form, a digital or virtual production line can be generated from the 3D mapping and object tracking.

The image processing units 406 and/or 522 then may include the action recognition and verification unit 608. At this point, each time step (or stamp) of the AMR monitoring with the camera images may have a 3D map thereby forming a sequence of the 3D maps to capture the production line operations in data of a sequence of the maps. The sequences of identified objects are then analyzed to determine separate viewed actions by a number of the object recognition techniques mentioned above. The identification is then verified by comparing the viewed actions to expected actions from the database 444 or other database to identify separate operations, such as movement by a single robot or single human operator. The verification is performed by inputting the viewed actions into a neural network trained to compare the viewed actions with the expected actions. When this initial comparison is sufficiently close, the identified operation may be labeled or tagged.

The subsequent operations for comparison between viewed and expected actions (and undesired actions), reaction generation, report generation, and historical archiving as performed at the plant system 400 level or at the AMRs are described below in processes 700 and 800.

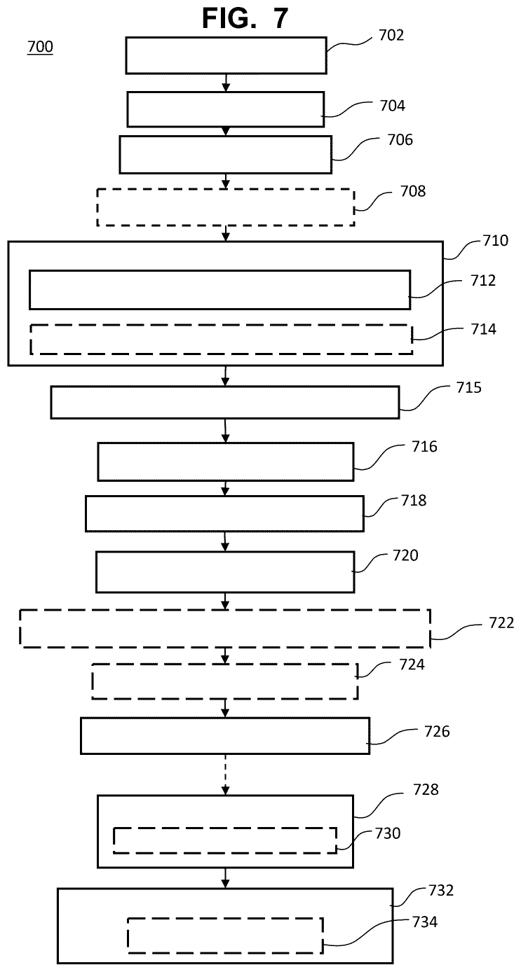

Referring to FIG. 7, a process 700 of operating an autonomous vehicle such as an autonomous mobile robot (AMR) used in the examples herein, is provided according to at least one of the implementations described herein. The process 700 is described with operations 702-734 generally numbered evenly. The systems, processes, vehicles, devices, vehicle displays, and components of FIGS. 1-6 may be referred to where relevant.

The process 700 may include “activate the AMR system” 702. By one form, the AMR systems (such 120, 220, and 401) are activated automatically as soon as power is provided to the AMRs 500 and the units of the AMR system 401 are launched. This may involve initializing AMR hardware such as motors, sensors, cameras and so forth as well as calibrating cameras and the sensors. The AMR 500 may start from an initial location that is at a base or recharging location for example, or otherwise may start from a payload loading dock location or any other desired location associated with providing the AMR 500 for production line operations.

Once the AMRs 500 and AMR system 401 are activated and running, the AMRs 500 may perform continuous monitoring, such as by using high speed cameras providing 30-120 frames per second (fps), but otherwise may use 1-30 fps, 15-30 fps, 30 fps, 60 fps, or other desired frame rates. Pre-processing of the raw image data, such as demosaicing, noise reduction, scaling, and so forth may be performed at the cameras themselves or by the ASR's image processing unit 522.

At the AMRs 500, process 700 may include “detect area map” 704, and as mentioned above may include using VSLAM or other techniques, and by one form, provide images in real-time. The result may be a 2D or 3D map of the production line area that may be used to form 3D models of the production line. The VSLAM or other algorithm may be performed continuously to generate a map with each frame, or at desired intervals such as once per 10 frames as one example, to generate a map at each desired mapping time interval. The 3D maps then may be used to track changes to the production line over time. As mentioned, each AMR 500 may generate its own local AMR-level 3D map, or a global map may be generated at each AMR or one or more AMRs when the image data is shared among the AMRs.

Process 700 may include “localize AMR on map” 706 where the VSLAM also recognizes the AMRs and simultaneously tracks the motion of the AMRs over time. The camera-based visual mapping and localization may include using the features and objects in the production line environment as fixed anchor locations, such as the object or column 318 (FIG. 3) to anchor the map and determine AMR positions relative to the anchor.

Process 700 optionally may include “retrieve payload” 708, and when one or more of the AMRs 500 are to carry a payload. In this case, the payloads are setup for loading onto AMRs 500. The AMR 500 uses the mapping and localization from the VLSAM to generate a path to a payload loading dock or area, or the AMR may determine it is already at a target payload loading location. The payload loading may be performed automatically by autonomous equipment on or separate from the AMR 500 such as grippers, cranes, conveyors, and/or autonomous forklifts, but otherwise manually by human operators by hand or using equipment such as dollies or manually driven forklifts, and so forth. Many different examples exist.

Thereafter, whether carrying a payload or not, process 700 may include “receive position instructions” 710, where the AMR may perform autonomous path planning to a target destination at or around the production line to perform monitoring of the production line and when assigned, to deliver a payload to the production line. The destination instructions may be looked up from onboard protocols or received from other units at the plant system 400 for example. The planning may occur before, during, or after the AMR 500 is located at the payload dock.

By one form, operation 710 may include “receive/determine initial production line position” 712, and this is provided when the AMR 500 is to at least generally maintain a single position at the production line, typically along with other AMRs so that each AMR is assigned a different production line section or zone to monitor, as with AMR system 120 (FIG. 1). The AMR 500 still may move back and forth from this position to obtain payloads or for other tasks such as to achieve a better view of an object or operation being performed within an assigned production line section for example. Such field of view adjustment to the AMR may be made autonomously or manually, and relatively quickly when desired.

Otherwise, operation 710 may include “receive operation/object assignment” 714, where the AMR 500 is not assigned a particular section of the production line, and instead is assigned a product being assembled or other object moving along the production line. In this case, the target destination is an initial position of the AMR. Once positioned at the production line, the AMR then will continuously identify or recognize the assigned object or product, and move along the production line while maintaining the assigned object or product within view of the local field of view of the local camera array on the AMR. In this case, a single AMR may be used rather than multiple AMRs, or multiple AMRs being used in parallel, each being assigned a moving object to monitor.

Other variations may be used such as assigning an object or product to an AMR only within a certain section of the production line, or moving all AMRs in a fixed order along the production line regardless of the presence or location of objects and products on the production line. Many other variations exist.

Process 700 may include “plan path from current position to destination” 715. The most up to date 3D (or other) map and localization data then may be used to generate a path from a current (or other significant and relevant) position of the AMR to the target destination. The path generation may consider actual and potential obstacles and traffic on the map, such as other AMRs, objects, and human operators detected on the map, other mapped or known obstacles or pathways, such as doorways, ramps, elevators, lifts, and other factors such as time consumption, just-in-time scheduling, speed limits, energy consumption, wearing down of physical components on the AMR, safety protocols, prohibited AMR travel zones, other designated zones, task prioritization and distances, size of payload when overload payloads extend needed clearance of the AMR, sensitivity of physical impacts on the payload or other equipment on the AMR such as bumps while the AMR is traveling, environmental conditions (lighting, temperature, etc.) that could affect computer vision while traveling, temporary or maintenance obstacles, backup or secondary paths if needed, and multi-AMR path planning sharing and cooperation to avoid paths generated by other AMRs. Many other factors may be considered that are not listed here as well.

Process 700 may include “travel to initial lineside position” 716, and where the AMR 500 then travels along the autonomously generated path considering factors as mentioned above, and while being free of predetermined fixed routes that cannot be changed by the AMR. The AMR may adjust its position using VSLAM and the other techniques mentioned above as well as sensor data to stay on course and refine the positioning of the AMR. The AMR travels to the instructed destination, here that may be lineside of a production line. This process of autonomously generating paths between a current position and destination may be repeated as needed, and may use paths to any desired destination provided to an AMR, whether on the lineside or other destination associated with the production line, typically within or on a factory or plant site, campus, or building. By other options, the AMR may be moved for other production lines (multiple production lines) or other reasons as desired.

By one form, the navigation unit 510 may perform the path planning, and the AMR local control 524 may communicate with the AMR control 404 and other plant operation systems 420 or users via AMR dashboard 414 to coordinate actions (e.g., sending commands to pause or reroute an AMR). The AMR local control 524 also may adjust the AMR's path based on real-time data received from the cameras that update any of the factors mentioned above.

When the destination is a payload delivery to the production line or lineside of the production line, in this case, other operations may be performed autonomously or manually, such as verification of precise docking or unloading point position and orientation of the AMR for proper unloading of the payload. This may be performed by using the cameras of the AMR, cameras of another AMR having the delivery AMR in view, and/or other onboard sensors (e.g., proximity sensors, and so forth).

Process 700 may include “monitor production line operations” 718 and “perform ongoing camera capture” 720, which refers to the AMR cameras 504 performing continuous image or video capture as mentioned above while maintaining a specific section of the production line in view or specific products, objects, or operations in view also as mentioned above. The captured sequences of images (or video sequences) from each camera are then stored at storage 518 for analysis by the AMR local control 524, navigation unit 510, and/or payload unit 512 to determine when a new payload should be retrieved.

Optionally, process 700 may include “move along production line with assigned object” 722, and by having the navigation unit 510 and AMR local control 524 perform the path generation as described above. This may include route monitoring and obstacle avoidance by continuously scanning the environment around the AMRs by using cameras, lidar, or other sensors as mentioned above to detect obstacles in a planned path. The path may be adjusted dynamically such as when obstacles are detected, and the VSLAM 3D map may be checked for consistency by verifying the AMR is localized correctly (factoring drift correction for example). The 3D map then may be updated as needed in real-time.

By another alternative, process 700 optionally may include “perform local image processing” 724, where one or more of the AMRs collect the image sequences or AMR level 3D maps and localization data from multiple AMRs 500 to generate a global 3D map. When the capacity of the AMR onboard systems exist, the AMR local control and other units also may perform the operation monitoring of AMR control 404 including the recognition of viewed operations, comparison to expected and undesired operations, and generation of a difference that can then be provided to the plant system level or that can be analyzed locally to determine reactions in response to the difference, such as changing the path or orientation of an AMR. Thus, the individual AMRs 500 themselves may have the ability to generate reports on performance, efficiency, and anomalies in the production process. By one form then, the local user input device 516 and display device 517 may provide an onboard AMR dashboard to display real-time data, trends, and alerts related to the assembly process, and then to receive input from a user or human operator at the plant floor.

Otherwise, the process 700 may include “transmit image data to AMR control” 726, where the AMR provides the plant system 400 with the camera inputs in the form of captured images as well as timestamped positions of the AMRs via onboard communications 514. In this example case, the input may include the AMR positions and either captured image sequences, or the generated AMR level 3D maps, or both that are then transmitted from the AMRs 500 and to the remote plant system 400 and particularly the AMR control 404. This may include transmitting raw sensor data and analyzed and computed AMR and/or production line metric values such as assembly speed, product counts, error rates, and so forth. Such analysis may be performed by using the image processing unit 522 and the AMR local control unit 524.

Continuing this example, after the camera input and other AMR data is transmitted to the remote plant system 400, process 700 may include “receive reaction instructions” 728 where instructions are received at the AMR 500 to change the operation of one or more AMRs 500 when a sufficiently significant difference in viewed action and expected action (or similarity of viewed action and undesired action) has been determined. The analysis of the differences are discussed below with process 800 and at the plant system 400 level. Here, the received instruction may include changing a planned path of an AMR or changing a position or orientation of an AMR, changing the object, production, or operation assigned to an AMR, or an instruction related to any other action of the AMR including an emergency stop of the AMR and other moving objects associated with the production line. The instructions may include signals to other computing devices such as robots assembling a part onto a product or other machinery involved with the assembling or other stages of forming and providing the finished product. By another form, the instructions include providing alerts or other data to be read or heard by a human operator or personnel, and whether on a computing device viewable by the operator on a display or on machinery or device at or associated with the production line including displays or audio speakers on the AMRs themselves, and this may include a printout on paper or other media.

By one form mentioned above, the instructions may be generated due to an action of one AMR that is observed by another AMR. As one example, it may be observed from one AMR that a different payload AMR is positioned too far from the production lineside such that a human operator manually unloading a payload from the payload AMR takes extra time to travel back and forth from the payload AMR. The instructions may command the payload AMR to move to a position closer to the lineside and the position where the human operator is working to reduce delay and increase efficiency.

By one option when a payload AMR carries a payload, operation 728 may include “receive payload instruction” 730 when it has been detected that the payload has been completely or sufficiently unloaded and more payload should be retrieved. This may have been triggered locally by the AMRs own cameras alone or via instructions from the plant system level and observation from images of another AMR viewing the payload AMR. The instructions may be a simple code that more payload is to be retrieved.

Process 700 may include “perform actions according to instructions” 732, where the AMR path, position, orientation, objectives, tasks, and so forth may be changed and executed by the AMR according to the instructions. This operation 732 may include “obtain next payload” 734 for the payload AMR that then determines a path back to the payload loading dock, leaves the lineside (or other) current position, and travels back to the payload loading dock along the autonomously generated path.

Referring now to FIG. 8, a process 800 of operating an autonomous mobile robot (AMR) system used in the examples herein, is provided according to at least one of the implementations described herein. The process 800 is described with operations 802-836 generally numbered evenly. The systems, processes, vehicles, devices, displays, and components of FIG. 17 may be referred to where relevant.

Process 800 may include “activate AMR system” 802, and this includes some of the same operations as the operation 702 of the process 704 for the AMRs. Here, the AMR system units at the plant system 400 as well as other systems and units may be launched if not already on a “always-on” mode.

Process 800 may include “receive image data from one or more AMRs” 804, and this may include the receiving of at least some version of the input described with transmission operation 726 including at least image sequences and timestamped positions of the AMRs, and optionally the 3D maps generated by the AMRs, sensor data, and calculated AMR and production line performance parameters such as production line assembly speeds, accuracy, and so forth.

Process 800 may include “pre-process image data” 806 and this may include any noise reduction, any other quality enhancement, scaling, and so forth so that the received images are in a format expected by the image processing unit 406 to be performed for viewed action recognition and action difference determinations.

Process 800 may include “generate 3D map of production line and localize AMR positions over time” 808, and by one form, this may include “use VSLAM” 810, and on the plant system side or level as well. Alternatively or additionally, algorithms other than VLSM may be used. This operation 808 may include “register images to each other from multiple cameras and/or multiple AMRs” 812. Thus, when the AMR local 3D maps are received from the AMRs at the image processing unit 406, the maps may be stitched together to form a global 3D map or model of the entire production line or a portion of the product line covered by all of the AMRs monitoring the production line. Otherwise, when the AMRs merely transmit the separate image or video sequences from the individual cameras, the image processing unit 406 may stitch together the individual video sequences to form the global 3D map. This may be performed by stitching together all of those images with the same or substantially same timestamp to form a 3D map at each time stamp. In any of these cases, VSLAM and/or other algorithms may be used to generate the global 3D maps and localize the AMRs on the 3D global maps. This may be performed continuously at each timestamp or each frame of the video sequences, or it may be sufficient to form a map at some interval such as once every 10 frames depending on the frame rate. By one form, the 3D maps may be converted into models such as meshes, point clouds, and voxel grids to name a few examples.

Process 800 may include “for initialization, provide monitoring assignment to AMR(s)” 814, and this may include “provide object to track” 816 as shown with AMR system 121 (FIG. 1B). In this operation, the data center and the PLCs 428, with or without user participation such as through the AMR dashboard 414 or other plant system interface, may assign a product being assembled or other object to be monitored by one or more AMRs. This initially may include assignment to a base, tray, crane, or other mover structure or body that is to hold or receive a product to be monitored. For payload AMRs, this operation 816 also may include instructions to have a replacement AMR monitor objects initially assigned to a payload AMR while the payload AMR is retrieving more payload. In this case, the system 400 may assign a replacement destination and a subsequent return destination to a replacement AMR as part of these instructions.

Otherwise, operation 814 may include “provide area to monitor” 818 as shown with AMR system 120, where an AMR is first assigned a section of a production line to monitor and does not necessarily move along the production line out of the assigned section unless the AMR has other tasks to perform such as carrying a payload. In this case, a replacement AMR may be used as described above. Many variations are contemplated. The process 800 then loops back to operation 804 to perform continuous monitoring.

Process 800 may include “identify viewed actions” 820, and this may involve the triangulation by the image processing unit 522 to determine the positions of other objects, such as human operators, machines, devices, sub-components of a product, tools, and so forth associated with a production line. The triangulation determines the positions of the objects by determining distances among the objects, AMRs, and any fixed anchor locations as described above with anchor 318 (FIG. 3). Object recognition algorithms may be applied as well, such as by VSLAM, to track all of the objects (AMRs and non-AMR objects and personnel) on the global 3D map over time.

The object recognition algorithms also then may be used (if not performed already) in initial action recognition operations to identify the same objects moving through time on the global 3D map or model that are potentially a separate viewed action. This is repeated for each potential separate viewed action. Each action may be labeled or tagged. This may include semantic object recognition and providing labels and/or annotation to the recognized viewed objects.

Once sequences of moving objects are detected as initial or potential viewed objects in the image sequences, viewed operation recognition may be verified by comparing the moving object sequences to datasets representing operations in both desired (expected) and undesired (unexpected) states. The database 444 may have a library of both of these datasets as well as correspondence between expected and undesired sequences for the same objects. Neural networks may be used to input the image data from the image sequences and that are trained to compare the moving object sequences to the datasets. The neural networks may be trained by using human feedback to continuously improve the object recognition accuracy.

Process 800 may include “obtain expected actions” 822, and this refers to obtaining these actions to determine action difference values rather than the initial recognition and verification of a viewed object. It is understood that these may be considered simultaneous operations, but is treated as sperate operations here for clarity. Thus, the datasets may be obtained from the same library and database 444 as those used to identify the viewed actions in the first place.

Process 800 may include “determine action differences” 824. Thus, as mentioned, this operation refers to either (1) generating the differences between the expected actions and the viewed actions or (2) retrieving those differences if already determined when first identifying the viewed actions. This also may include comparing the viewed actions to undesired actions already in the historical undesired action dataset. When such a match occurs, the precise reason for the mismatch between viewed and expected action may be identified in the historical data.

By one example approach, training of any of the neural networks or other machine learning models mentioned herein may be performed to assess the accuracy and efficiency of the networks and models to improve the networks and models over time.

Process 800 may include “report actions and differences to production line operational systems” 826. In this example, the differences and related data may be provided to the PLCs 428 or other plant operational system. The PLC 420 then decides as to how to react to the difference between the viewed and expected and undesired actions. This may simply involve looking up previous reactions when the undesired action has been identified by a match to previous undesired actions already experienced (or simulated) and added to a dataset. Otherwise, the PLC 428 may have programming to determine the appropriate reaction and may generate instructions or commands to execute the reaction. For example, the PLC 428 may form instructions to tell a machine to stop, make an AMR perform a task, or trigger the next step in production.

Otherwise, the PLC 428 may signal the E-stop unit 424 to stop operations at the production line, whether by stopping the entire plant or specific AMRs or machines. Also, the PLC 428 may issue alerts by the alert unit 426 and to personnel at the production line, at the plant, plant system center or level, or other location controlling or monitoring actions at the production line. When the differences show a state of payload on a payload AMR, then a PLC may send a signal to the materials unit 422 (if not received directly from the communications unit 410) to initiate retrieval of more payload such as by signaling the payload unit 434 to control an AMR 500 to retrieve more payload.

Process 800 may include “receive automatic reaction instructions” 828, and in the case where a PLC 428 determines the difference is an urgent matter, or user participation is not needed, instructions may be sent to the AMR control 404 to immediately change the operation of an AMR or directly to other machinery associated with the production line to immediately change the operation or actions with the other machinery.

Otherwise, the process 800 may include “provide actions and differences to AMR system dashboard” 830, where a user can provide input to determine the proper reactions. This will typically be used for non-urgent matters or after an urgent reaction was implemented and to assess the reaction and determine if a different reaction should be implemented if the same undesired viewed action occurs in the future. This may include having the PLC 428 issue a pre-written script for a display to show a user or operator. Based on the data by the system, the PLC 428 may use ladder logic to drive a set of commands to a stack light alert system on machinery or AMRs, software AMR dashboard 414, or other connected systems for an operator to easily understand if there is further action required based on the observations made by the cameras.

Process 800 may include “receive manual reaction instructions” 832, where a user or operator may provide instructions for a proper reaction, and including updating the programming code of the AMRs or other devices or systems when desired.

Process 800 may include “transmit instructions to AMRs” 834, or other devices at the production line or associated with the production line to implement the manual reactions, or reactions with manual contributions.

Process 800 may include “store actions, differences, and reactions in historical archive” 836, where these elements are stored for tracking in a historical archive, and where relevant, viewed actions and correspondence to an expected action may be added to the datasets of database 444 for training and operation of action differencing neural networks for example.

Herein, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connected” or “coupled to” used in describing a relationship between different elements or parts of the nozzle do not imply that a direct physical connection must be made between these elements, unless mentioned otherwise. For example, two elements may be connected to each other physically, electronically, logically, or in any other manner, through one or more additional elements.

While at least one example implementation has been presented in the foregoing detailed description, it should be appreciated that a vast number of variations exist. It should also be appreciated that the example implementations are not intended to limit the scope, applicability, or configuration of the disclosure in any way. Rather, the foregoing detailed description will provide those skilled in the art with a convenient road map for implementing the example implementations. It should be understood that various changes can be made in the function and arrangement of elements without departing from the scope of the disclosure as set forth in the appended claims and the legal equivalents thereof.

What is claimed is:

1. A method comprising:
operating, by at least one processor, at least one autonomous vehicle having multiple cameras and disposed to move in a vicinity of an object to be monitored, wherein the vicinity is within a three dimensional space having overhead equipment to be avoided, wherein the operating comprises:
automatically moving the at least one autonomous vehicle in the vicinity of the object while free of a predetermined fixed route, and
capturing, by the multiple cameras, at least one sequence of images of an area including at least part of the object;
automatically recognizing, by at least one processor, at least one change associated with the object and captured in the at least one sequence of images; and
providing instructions, by at least one processor, to perform a reaction in response to the recognized change.

2. The method of claim 1, wherein the object is a production line arranged to provide a product, wherein the change is motion of an operation associated with the production line, and wherein the response includes responding to viewed actions of the recognized operation.

3. The method of claim 2, comprising operating the at least one autonomous vehicle to move along the production line to maintain an object within a field of view of at least one of the cameras.

4. The method of claim 2, comprising operating multiple autonomous vehicles each capturing a different field of view of the production line to track an object traveling along the production line and passing through multiple ones of the fields of view.

5. The method of claim 2, comprising arranging a first autonomous vehicle to be monitored by one or more cameras of a second autonomous vehicle, and
wherein the instructions include modifications of one or more actions to be performed by the first autonomous vehicle depending on the viewed actions captured by the one or more cameras of the second autonomous vehicle.

6. The method of claim 2, comprising: carrying a loaded payload on the at least one autonomous vehicle; automatically detecting when at least a portion of the loaded payload is removed from the at least one autonomous vehicle or used in association with the production line or both by using the at least one sequence of images; and instructing the at least one autonomous vehicle to retrieve more payload when the detecting indicates at least the portion of the loaded payload was removed.

7. The method of claim 2, comprising generating a 3D map of the production line that changes over time; and determining and tracking a position and motion of the at least one autonomous vehicle on the 3D map by using the at least one sequence of images; and using a visual simultaneous localization and mapping (VSLAM) algorithm to generate the 3D map of the production line and track the motion of the at least one autonomous vehicle.

8. The method of claim 2, wherein multiple autonomous vehicles provide multiple sequences of images, and wherein the method comprises registering images together from different ones of the multiple autonomous vehicles to generate a 3D map of the production line.

9. The method of claim 2, comprising: comparing data of images of predetermined desired expected actions or previously recorded undesired actions or both to the viewed actions;
and determining the instructions depending on results of the comparing.

10. A system, comprising:
memory,
processor circuitry forming at least one processor communicatively coupled to the memory and being arranged to operate by:
operating at least one autonomous vehicle having multiple cameras and disposed to move in a vicinity of a production line arranged to provide a product, wherein the operating comprises:
automatically moving the at least one autonomous vehicle in the vicinity of the production line while free of a predetermined fixed route, and
capturing, by the multiple cameras, at least one sequence of images of an area including at least part of the production line;
automatically recognizing at least one operation associated with the production line and captured in the at least one sequence of images; and
providing instructions to perform a reaction in response to viewed actions of the recognized operations, and wherein the reaction is associated with the production line.

11. The system of claim 10, wherein the at least one processor is arranged to operate by: determining one or more differences between the viewed actions and corresponding previously stored images of expected action or undesired action or both by using the at least one sequence of images; informing a user of the differences on a display device remote from the at least one autonomous vehicle, and receiving instructions from the user to modify planned motion of the at least one autonomous vehicle depending on the differences.

12. The system of claim 10, wherein the at least one processor is arranged to operate by generating real-time 3D maps and having data of the production line and positions of multiple autonomous vehicles changing over time and by using the at least one sequence of images.

13. The system of claim 10, wherein the at least one processor is arranged to operate by: comparing the viewed actions to images of expected actions or undesired actions or both to determine action differences; and generating contents of the reaction depending on the differences including providing all alternative options of (1) providing a signal to send to at least one of the autonomous vehicles, (2) providing a signal to send to at least one non-AMR device in a vicinity of the production line, and (3) providing data to inform a person of the action differences.

14. The system of claim 11, wherein the at least one autonomous vehicle has a body connected to a movement mechanism, a base, and a payload area disposed above the base, wherein the base comprises sidewalls disposed below the payload area and having the multiple cameras each facing in an outwardly direction from the base.

15. The system of claim 10, wherein the multiple cameras are positioned on individual autonomous vehicles to capture images in 360 degrees horizontally around the individual autonomous vehicle.

16. At least one non-transitory computer-readable medium comprising instructions thereon that when executed by a computing device, cause the computing device to operate by:
operating at least one autonomous vehicle having multiple cameras and disposed to move in a vicinity of a production line arranged to provide a product, wherein the operating comprises:
automatically moving the at least one autonomous vehicle in the vicinity of the production line while free of a predetermined fixed route, and
capturing, by the multiple cameras, at least one sequence of images of an area including at least part of the production line;
automatically recognizing at least one operation associated with the production line and captured in the at least one sequence of images; and
providing instructions to perform a reaction in response to viewed actions of the recognized operations, and wherein the reaction is associated with the production line.

17. The medium of claim 16, wherein the instructions cause the computing device to operate by moving one of the autonomous vehicles along the production line to maintain one or more objects moving on the production line in view of the multiple cameras on the one autonomous vehicle.

18. The medium of claim 17, wherein the instructions cause the computing device to operate by having multiple autonomous vehicles moving along the production line each following and capturing images of a different object moving along the production line.

19. The medium of claim 16, wherein the at least one autonomous vehicle is arranged to monitor objects associated with the production line including at least one of: human operators, other autonomous vehicles of the at least one autonomous vehicle, objects moving in association with the production line, objects being added to the product, tools being used to assemble the product, objects moved from or to the at least one autonomous vehicle, and motion of robots.

20. The medium of claim 16, wherein the at least one autonomous vehicle is arranged to track objects associated with at least one production line stage of: material preparation, fabricating components of the product, subassembly of parts of the product, assembly of the product, quality control testing of the product, surface treatment of the product, packaging of the product, storage of the product, and shipping of the product.
